(19) United States
(12) Patent Application Publication
(10) Pub. No.: US 2007/0233805 A1
(43) Pub. Date: Oct. 4, 2007

(54) Distribution of parallel operations

(75) Inventors: Laurence Grodd, Portland, OR (US); Robert A. Todd, Sherwood, OR (US); Jimmy Jason Tomblin, Portland, OR (US)

Correspondence Address: BANNER & WITCOFF, LTD., 1100 13th STREET, N.W., SUITE 1200, WASHINGTON, DC, 20005-4051, US

(73) Assignee: Mentor Graphics Corp., Wilsonville, OR (US)

(21) Appl. No.: 11/396,929

(22) Filed: Apr. 2, 2006

(51) Int. Cl. G06F 15/16

(52) U.S. Cl. 709/208

(57) ABSTRACT

Parallel operation sets for use by a software application are identified. Each parallel operation set is then provided to a master computing thread for processing, together with its associated process data. Each master computing thread will then provide its operation set to one or more slave computers based upon parallelism in the process data associated with its operation set. In this manner, the execution of operations by a software application is widely distributed among multiple networked computers based upon parallelism in both the process data used by the software and the operations executed by the software application.

### FIELD OF THE INVENTION

The present invention is directed to the distribution of parallel operations from a master computer to one or more slave computers. Various aspects of the invention may be applicable to the distribution of software operations, such as microdevice design process operations, from a multi-processor, multi-threaded master computer to one or more single-processor or multi-processor slave computers.

### BACKGROUND OF THE INVENTION

Many software applications can be efficiently run on a single-processor computer. Some software applications, however, have so many operations that they cannot be sequentially executed on a single-processor computer in an economical amount of time. For example, microdevice design process software applications may require the execution of a hundred thousand or more operations on hundreds of thousands or even millions of input data values. In order to run this type of software application more quickly, computers were developed that employed multiple processors capable of simultaneously using multiple processing threads. While these computers can execute complex software applications more quickly than single-processor computers, these multi-processor computers are very expensive to purchase and maintain. With multi-processor computers, the processors execute numerous operations simultaneously, so they must employ specialized operating systems to coordinate the concurrent execution of related operations. Further, because its multiple processors may simultaneously seek access to resources such as memory, the bus structure and physical layout of a multi-processor computer is inherently more complex than a single processor computer.

In view of the difficulties and expense involved with large multi-processor computers, networks of linked single-processor computers have become a popular alternative to using a single multi-processor computer. The cost of conventional single-processor computers, such as personal computers, has dropped significantly in the last few years. Moreover, techniques for linking the operation of multiple single-processor computers into a network have become more sophisticated and reliable. Accordingly, multi-million dollar, multi-processor computers are now typically being replaced with networks or “farms” of relatively simple and low-cost single processor computers.

Shifting from single multi-processor computers to multiple networked single-processor computers has been particularly useful where the data being processed has parallelism. With this type of data, one portion of the data is independent of another portion of the data. That is, manipulation of a first portion of the data does not require knowledge of or access to a second portion of the data. Thus, one single-processor computer can execute an operation on the first portion of the data while another single-processor computer can simultaneously execute the same operation on the second portion of the data. By using multiple computers to execute the same operation on different groups of data at the same time, i.e., in “parallel,” large amounts of data can be processed quickly. This use of multiple single-processor computers has been particularly beneficial for analyzing microdevice design data. With this type of data, one portion of the design, such as a semiconductor gate in a first area of a microcircuit, may be completely independent from another portion of the design, such as a wiring line in a second area of the microcircuit. Design analysis operations, such as operations defining a minimum width check of a structure, can thus be executed by one computer for the gate while another computer executes the same operations for the wiring line.

The use of multiple networked single-processor computers still presents some drawbacks, however. For example, the efficiencies obtained by using multiple networked computers are currently limited by the parallelism of the data being processed. If the processing data associated with a group of operations has only four parallel portions, then those operations can only be executed by four different computers at most. Even if the user has a hundred more computers available in the network, the data cannot be divided into more than the four parallel portions. The other available computers must instead remain idle while the operations are performed on the four computers having the parallel portions of the data. This lack of scalability is extremely frustrating for users who would like to reduce the processing time for complex software applications by adding additional computing resources to a network. It thus would be desirable to be able to more widely distribute processing data among multiple computers in a network for processing.

### SUMMARY OF THE INVENTION

Advantageously, various aspects of the invention provide techniques to more efficiently distribute process data for a software application among a plurality of computers. As will be discussed in detail below, embodiments of both tools and methods implementing these techniques have particular application for distributing microdevice design data from a multi-processor computer to one or more single-processor computers in a network for analysis.

According to various embodiments of the invention, parallel operation sets are identified. As will be discussed in detail below, two operation sets are parallel where executing one of the operation sets does not require results obtained from a previous execution of the other operation set, and vice versa. Each parallel operation set is then provided to a master computing thread for processing, together with its associated process data. For example, a first operation set may be provided to a first master computing thread, along with first process data that will be used to execute the first operation set. A second operation set may then be provided to a second master computing thread, along with second process data that will be used to execute the second operation set. Because the first operation set is parallel to the second operation set, the first master computing thread can process the first operation set while the second master computing thread processes the second operation set.

With various examples of the invention, each master computing thread may then provide its operation set to one or more slave computers based upon parallelism in the process data associated with its operation set. For example, if the process data contains two parallel portions, it may provide the first portion to a first slave computing thread. The master computing thread can then execute the operation set using the second portion of the process data while the first slave computing thread executes the operation set using the first portion of the process data. In this manner, the execution of a software application can be more widely distributed among multiple networked computers based upon parallelism in both the process data used by the software application and the operations to be performed by the software application.

These and other features and aspects of the invention will be apparent upon consideration of the following detailed description.

### BRIEF DESCRIPTION OF THE DRAWINGS

FIG. 1 is a schematic diagram of a multi-processor computer linked with a network of single-processor computers as may be employed by various embodiments of the invention.

FIG. 2 schematically illustrates an example of a hierarchical arrangement of data cells that may be employed by various embodiments of the invention.

FIG. 3 schematically illustrates an example of a hierarchical arrangement of operations that may be employed by various embodiments of the invention.

FIG. 4 illustrates an operation distribution tool that may be implemented according to various embodiments of the invention.

FIGS. 5A and 5B illustrate a flowchart describing a method for distributing operation sets among master computing units according to various embodiments of the invention.

FIG. 6 illustrates a flowchart describing a method for distributing an operation set among slave computing units for processing according to various embodiments of the invention.

### DETAILED DESCRIPTION OF PREFERRED EMBODIMENTS

Introduction

Various embodiments of the invention relate to tools and methods for distributing operations among multiple networked computers for execution. As noted above, aspects of some embodiments of the invention have particular application to the distribution of operations among a computing network including at least one multi-processor master computer and a plurality of single-processor slave computers. Accordingly, to better facilitate an understanding of the invention, an example of a network having a multi-processor master computer linked to a plurality of single-processor slave computers will be discussed.

Exemplary Operating Environment

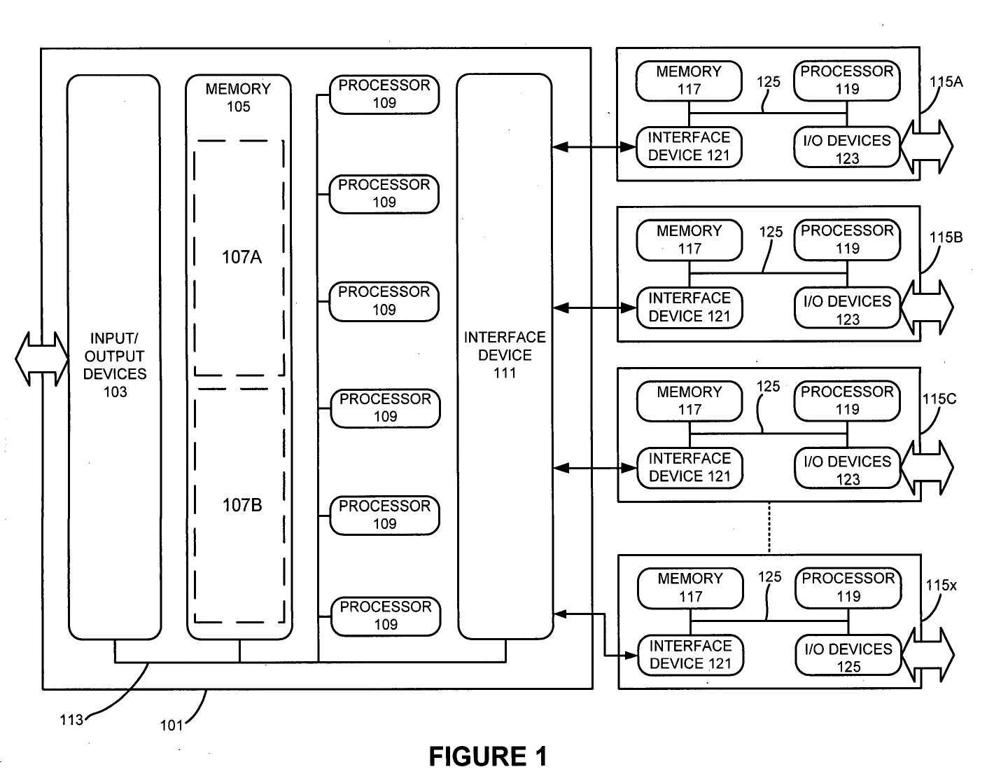

As will be appreciated by those of ordinary skill in the art, operation distribution according to various examples of the invention will typically be implemented using computer-executable software instructions executed by one or more programmable computing devices. Because the invention may be implemented using software instructions, the components and operation of a generic programmable computer system on which various embodiments of the invention may be employed will first be described. More particularly, the components and operation of a computer network having a host or master computer and one or more remote or slave computers will be described with reference to FIG. 1. This operating environment is only one example of a suitable operating environment, however, and is not intended to suggest any limitation as to the scope of use or functionality of the invention.

In FIG. 1, the master computer 101 is a multi-processor computer that includes a plurality of input and output devices 103 and a memory 105. The input and output devices 103 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 105 may similarly be implemented using any combination of computer readable media that can be accessed by the master computer 101. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 101 runs a software application for performing one or more operations according to various examples of the invention. Accordingly, the memory 105 stores software instructions 107A that, when executed, will implement a software application for performing one or more operations. The memory 105 also stores data 107B to be used with the software application. In the illustrated embodiment, the data 107B contains process data that the software application uses to perform the operations, at least some of which may be parallel.

The master computer 101 also includes a plurality of processors 109 and an interface device 111. The processors 109 may be any type of processing device that can be programmed to execute the software instructions 107A. The processors 109 may be commercially generic programmable microprocessors, such as Intel® Pentium® or Xeon™ microprocessors, Advanced Micro Devices Athlon™ microprocessors or Motorola 68K/Coldfire® microprocessors. Alternately, the processors 109 may be custom-manufactured processors, such as microprocessors designed to optimally perform specific types of mathematical operations. The interface device 111, the processors 109, the memory 105 and the input/output devices 103 are connected together by a bus 113.

The interface device 111 allows the master computer 101 to communicate with the remote slave computers 115A, 115B, 115C . . . 115x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The protocols and implementations of various types of communication interfaces are well known in the art, and thus will not be discussed in detail here.

Each slave computer 115 includes a memory 117, a processor 119, an interface device 121, and, optionally, one more input/output devices 123 connected together by a system bus 125. As with the master computer 101, the optional input/output devices 123 for the slave computers 115 may include any conventional input or output devices, such as keyboards, pointing devices, microphones, display monitors, speakers, and printers. Similarly, the processors 119 may be any type of conventional or custom-manufactured programmable processor device, while the memory 117 may be implemented using any combination of the computer readable media discussed above. Like the interface device 111, the interface devices 121 allow the slave computers 115 to communicate with the master computer 101 over the communication interface.

In the illustrated example, the master computer 101 is a multi-processor computer, while the slave computers 115 are single-processor computers. It should be noted, however, that alternate embodiments of the invention may employ a single-processor master computer. Further, one or more of the remote computers 115 may have multiple processors, depending upon their intended use. Also, while only a single interface device 111 is illustrated for the host computer 101, it should be noted that, with alternate embodiments of the invention, the computer 101 may use two or more different interface devices 111 for communicating with the remote computers 115 over multiple communication interfaces.

Parallel Process Data

As discussed above, with various examples of the invention, the process data in the data 107B, will have some amount of parallelism. For example, the process data, such as design data for a microdevice, may be data having a hierarchical arrangement, such as design data for a microdevice. The most well-known type of microdevice is a microcircuit, also commonly referred to as a microchip or integrated circuit. Microcircuit devices are used in a variety of products, from automobiles to microwaves to personal computers. Other types of microdevices, such as microelectromechanical (MEM) devices, may include optical devices, mechanical machines and static storage devices. These microdevices show promise to be as important as microcircuit devices are currently.

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. The design data describing a 128 kB memory array can then be concisely described as a combination of only 64,000 register cells, together with the design data describing its own miscellaneous circuitry, such as an input/output circuit for transferring data into and out of each of the register cells.

Thus, a data structure divided into cells typically will have the cells arranged in a hierarchical manner. The lowest level of cells may include only the basic elements of the data structure. A medium level of cells may then include one or more of the low-level cells, and a higher level of cells may then include one or more of the medium-level cells, and so on. Further, with some data structures, a cell may include one or more lower-level cells in addition to basic elements of the data structure.

By categorizing data into hierarchical cells, large data structures can be processed more quickly and efficiently. For example, a circuit designer typically will analyze a design to ensure that each circuit feature described in the design complies with specific design rules. With the above example, instead of having to analyze each feature in the entire 128 kB memory array, a design rule check software application can analyze the features in a single bit cell. The results of the check will then be applicable to all of the single bit cells. Once it has confirmed that one instance of the single bit cells complies with the design rules, the design rule check software application can complete the analysis of a register cell by analyzing the features of its miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of its miscellaneous circuitry. Thus, the analysis of a large data structure can be compressed into the analyses of a relatively small number of cells making up the data structure.

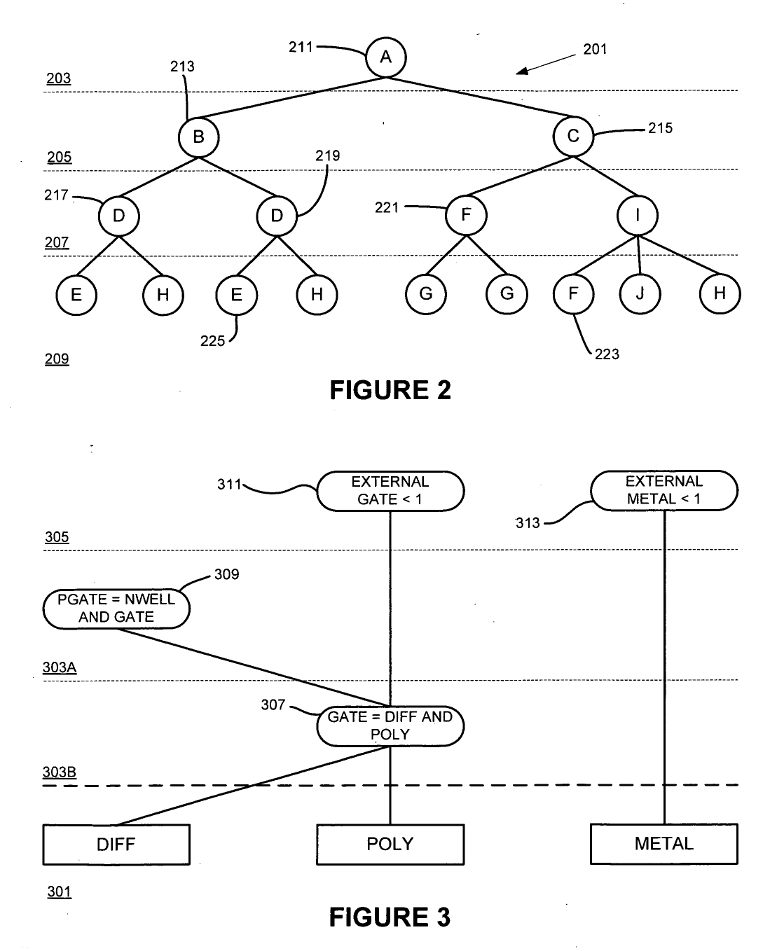

FIG. 2 graphically illustrates how process data can be organized into various hierarchical cells. In this figure, each cell contains a portion of the data 201, indicated by a letter ranging from “A” to “J.” The data 201 in the database is divided into four hierarchical levels 203-209. The highest level 203 contains only a single cell 211, while the second highest level 205 contains two cells 213 and 215. With this arrangement, a process operation cannot be accurately performed using the data in the highest level cell 211 until its precedent cells 213 and 215 have been similarly processed. Likewise, the data in the second level cell 213 cannot be processed until its precedent third-level cells 217 and 219 have been processed. As illustrated in this figure, the same cell may occur in multiple hierarchical levels. For example, the cell 221 is in the third hierarchical level 207 while the cell 223 is in the fourth hierarchical level 209, but both cells 221 and 223 contain the same cell data (identified by the letter “F” in the figure). Thus, design data relating to a specific structure, such as a transistor, may be repeatedly used in different hierarchical levels of the process data.

It should be noted that the hierarchy of the cells in the process data may be based upon any desired criteria. For example, with microdevice design data, the hierarchy of the cells may be organized so that cells for larger structures incorporate cells for smaller structures. With other implementations of the invention, however, the hierarchy of the cells may be based upon alternate criteria such as, for example, the stacking order of individual material layers in the microdevice. A portion of the design data for structures that occur in one layer of the microdevice thus may be assigned to a cell in a first hierarchical level. Another portion of the design data corresponding to structures that occur in a higher layer of the microdevice may then be assigned to a cell in a second hierarchical level different from the first hierarchical level. Still further, various examples of the invention may create parallelism. For example, of the process data is microdevice design data, some implementations of the invention may divide an area of the microdevice design into arbitrary regions, and then employ each region as a cell. This technique, sometimes referred to as “bin injection,” may be used to increase the occurrences of parallelism in process data.

From the foregoing explanation, it will be apparent that some portions of design data may be dependent upon other portions of the design data. For example, design data for a register cell inherently includes the design data for a single bit memory cell. Accordingly, a design rule check operation cannot be performed on the register cell until after the same design rule check operation has been performed on the single bit memory cell. A hierarchical arrangement of microdevice design data also will have independent portions, however. For example, a cell containing design data for a 16 bit comparator will be independent of the register cell. While a “higher” cell may include both a comparator cell and a register cell, one cell does not include the other cell. Instead, the data in these two lower cells are parallel. Because these cells are parallel, the same design rule check operation can be performed on both cells simultaneously without conflict. A first computing thread can thus execute a design rule check operation on the register cell while a separate, second computing thread executes the same design rule check operation on the comparator cell.

Parallel Operations

As previously noted, embodiments of the invention can be employed with a variety of different types of software applications. Some embodiments of the invention, however, may be particularly useful for software applications that simulate, verify or modify design data representing a microcircuit. Designing and fabricating microcircuit devices involves many steps during a ‘design flow,’ which are highly dependent on the type of microcircuit, the complexity, the design team, and the microcircuit fabricator or foundry. Several steps are common to all design flows: first a design specification is modeled logically, typically in a hardware design language (HDL). Software and hardware “tools” then verify the design at various stages of the design flow by running software simulators and/or hardware emulators, and errors are corrected. After the logical design is deemed satisfactory, it is converted into physical design data by synthesis software.

The physical design data may represent, for example, the geometric pattern that will be written onto a mask used to fabricate the desired microcircuit device in a photolithographic process at a foundry. It is very important that the physical design information accurately embody the design specification and logical design for proper operation of the device. Further, because the physical design data is employed to create masks used at a foundry, the data must conform to foundry requirements. Each foundry specifies its own physical design parameters for compliance with their process, equipment, and techniques. Examples of such simulation and verification tools are described in U.S. Pat. No. 6,230,299 to McSherry et al., issued May 8, 2001, U.S. Pat. No. 6,249,903 to McSherry et al., issued Jun. 19, 2001, U.S. Pat. No. 6,339,836 to Eisenhofer et al., issued Jan. 15, 2002, U.S. Pat. No. 6,397,372 to Bozkus et al., issued May 28, 2002, U.S. Pat. No. 6,415,421 to Anderson et al., issued Jul. 2, 2002, and U.S. Pat. No. 6,425,113 to Anderson et al., issued Jul. 23, 2002, each of which are incorporated entirely herein by reference.

Like process data, operations performed by a software application also may have a hierarchical organization with parallelism. To illustrate an example of operation parallelism, a software application that implements a design rule check process for physical design data of a microcircuit will be described. This type of software application performs operations on process data that defines geometric features of the microcircuit. For example, a transistor gate is created at the intersection of a region of polysilicon material and a region of diffusion material. Accordingly, design data representing a transistor gate will be made up of a polygon in a layer of polysilicon material and an overlapping polygon in a layer of diffusion material.

Typically, microcircuit physical design data will include two different types of data: “drawn layer” design data and “derived layer” design data. The drawn layer data describes polygons drawn in the layers of material that will form the microcircuit. The drawn layer data will usually include polygons in metal layers, diffusion layers, and polysilicon layers. The derived layers will then include features made up of combinations of drawn layer data and other derived layer data. For example, with the transistor gate described above, the derived layer design data describing the gate will be derived from the intersection of a polygon in the polysilicon material layer and a polygon in the diffusion material layer.

Typically, a design rule check software application will perform two types of operations: “check” operations that confirm whether design data values comply with specified parameters, and “derivation” operations that create derived layer data. For example, transistor gate design data may be created by the following derivation operation:
gate=diff AND poly

The results of this operation will identify all intersections of diffusion layer polygons with polysilicon layer polygons. Likewise, a p-type transistor gate, formed by doping the diffusion layer with n-type material, is identified by the following derivation operation:
pgate=nwell AND gate

The results of this operation then will identify all transistor gates (i.e., intersections of diffusion layer polygons with polysilicon layer polygons) where the polygons in the diffusion layer have been doped with n-type material.

A check operation will then define a parameter or a parameter range for a data design value. For example, a user may want to ensure that no metal wiring line is within a micron of another wiring line. This type of analysis may be performed by the following check operation:
external metal<1

The results of this operation will identify each polygon in the metal layer design data that are closer than one micron to another polygon in the metal layer design data.

Also, while the above operation employs drawn layer data, check operations may be performed on derived layer data as well. For example, if a user wanted to confirm that no transistor gate is located within one micron of another gate, the design rule check process might include the following check operation:
external gate<1

The results of this operation will identify all gate design data representing gates that are positioned less than one micron from another gate. It should be appreciated, however, that this check operation cannot be performed until a derivation operation identifying the gates from the drawn layer design data has been performed.

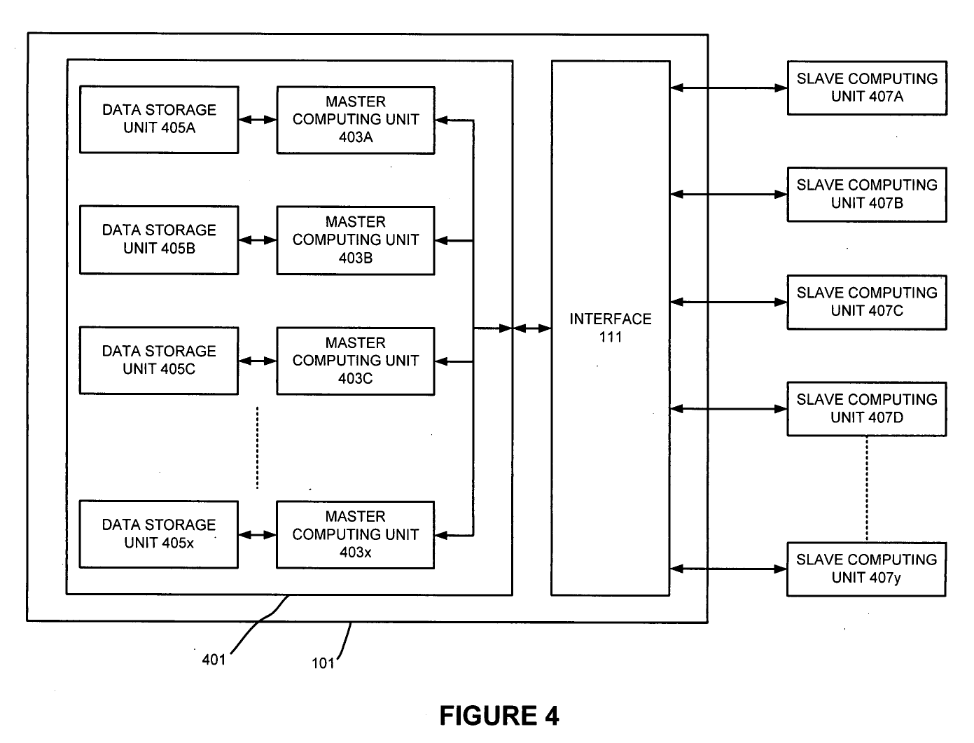

Accordingly, operation data may have a hierarchical arrangement. FIG. 3, for example, graphically illustrates the hierarchical arrangement of the derivation and check operations discussed above. As seen in this figure, the lowest tier 301 of this hierarchical arrangement includes the drawn layer design data. Various tiers 303 of derived operations make up the intermediate levels of the hierarchy. The uppermost tier 305 of the then hierarchy will be made up of check operations. As may also be seen from this figure, some of the operations will be dependent upon other operations. For example, the derivation operation 307 (i.e., gate=diff AND poly) must be executed before the derivation operation 309 (i.e., pgate=nwell AND gate) or the check operation 311 (i.e., external gate<1). It may also be seen from this figure that some operations will be independent of other operations. For example, the check operation 313 (i.e., external metal<1) does not employ any of the derived layer design data or drawn layer design data employed by the operations 307-311. Thus, the check operation 313 is parallel to the operations 307-311, and can be executed simultaneously with any of the operations 307-311 without creating a conflict in the design data. Similarly, the operation 309 is parallel to the operation 311, as the output data produced by one operation will not conflict with the output data produced by the other operation.

An Operation Distribution Tool

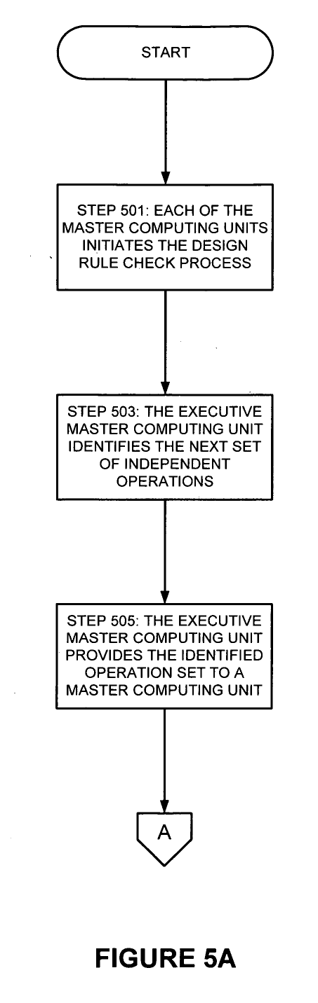

FIG. 4 illustrates an operation distribution tool 401 that may be implemented according to various examples of the invention. As shown in this figure, the tool 401 may be implemented on a multiprocessor computer 101 of the type shown in FIG. 1. It should be appreciated, however, that alternate embodiments of the distribution tool 401 may be implemented using a variety of master-slave computer networks.

As seen in FIG. 4, the operation distribution tool 401 includes a plurality of master computing units 403 and a plurality of data storage units 405. Each master computing unit 403 may be implemented by, for example, a processor 109 in the multiprocessor computer 101. Also, as will be discussed in more detail below, each master computing unit 403 will run a computing thread for executing software operations. In the illustrated example, a data storage unit 405 is associated with each of the master computing units 403. With some examples of the invention, the data storage units 405 may be virtual data storage units implemented by a single physical storage medium, such as the memory 105. With alternate examples of the invention, however, one or more of the data storage units 405 may be implemented by separate physical storage mediums.

As will also be discussed in detail below, at least one of the data storage units 405 will include the operations that must be executed to perform a desired design rule check. This data storage unit 405 also will contain both the process data for performing the operations and relationship data defining the portions of the process data required to perform each operation. For examples, if the tool 401 is being used to conduct a design rule check process for a microcircuit design, then at least one of the data storage units 405 will include both the drawn layer design data and the derived layer design data for the microcircuit. It also will include relationship data associating each operation with the layers of design data required to execute that operation. Each of the remaining data storage units 405 then stores the relationship information associating each operation with the portions of the design data required to execute that operation.

In the illustrated example, the master computing units 403 are connected both to each other and to a plurality of slave computing units 407 through an interface 111. Each slave computing unit 407 may be implemented, for example, by a remote slave computer 115. Also, each slave computing unit 407 may have its own dedicated local memory store unit (not shown).

Method of Distributing Operations

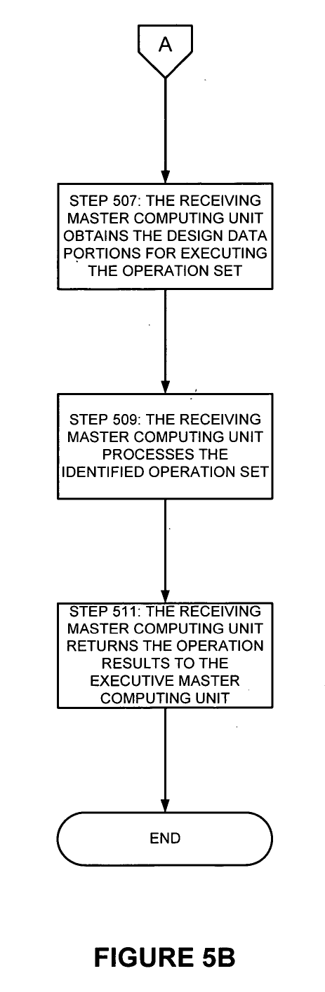

FIGS. 5A-5C illustrate a method of employing the operation distribution tool 401 to distribute operations according to various embodiments of the invention. More particularly, these figures illustrate a method of distributing operations for a design rule check process used to analyze a microdevice design. It should be appreciated, however, that the illustrated method may also be employed both with different distribution tools according to alternate embodiments of the invention, and for different types of software application processes other than design rule check processes. For example, various implementations of the invention may be used to execute a layout-versus-schematic (LVS) verification software application, a phase shift mask (PSM) software application, an optical and process correction (OPC) software application, an optical and process rule check (ORC) software application, a resolution enhancement technique (RET) software application, or any other software application that performs operations with parallelism using process data with parallelism.

Referring now to FIG. 5A, in step 501 each of the master computing units 403 initiates a computing thread to execute an instantiation of the design rule check process. The design rule check process may be, for example, implemented using the CALIBRE software application available from Mentor Graphics Corporation of Wilsonville, Oreg. As will be discussed in more detail below, one of the master computing units 403 serves as an executive master computing unit 403 that assigns operations to the other subordinate master computing units 403. Accordingly, with some examples of the invention, the executive master computing unit 403 may initiate the first instance of the design rule check process. The specific operations that will be performed according to the design rule check process, the design data, and the relationship data will then be stored in the data storage unit 405 used by the executive master computing unit 403. Once the executive master computing unit 403 has initiated a version of the design rule check process, it will initiate a version of the design rule check process on a computing thread in each of the subordinate master computing units 403. The executive master computing unit 403 also initially will provide the data storage units 405 (employed by the subordinate master computing units 403) with the relationship data.

Next, in step 503, the executive master computing unit 403 will identify the next set of independent operations that can be executed. The executive master computing unit 403 may, for example, create a tree describing the dependency relationship between different operations, such as the tree illustrated in FIG. 3. The executive master computing unit 403 can then traverse each node in the tree, to determine (1) if the operation at that node already has been executed, and (2) if the operation at that node depends upon the execution of the operation at another node that has not yet been executed. If one or more operations have not yet been executed and do not require the execution of another operation, then the operations will identified as the next set of independent operations.

Typically, a set of independent operations will include only a single operation. As will be discussed in more detail below, however, two or more operations may be concurrent operations that can be more efficiently executed together. Accordingly, some operation sets will include two or more concurrent operations. Also, in some instances, it may be possible to consecutively execute two or more non-concurrent operations together without creating conflicts in the design data. With various examples of the invention, these non-concurrent operations also may be included in a single operation set.

Once it has identified the next independent operation set for execution, in step 505 the executive master computing unit 403 provides the identified operation set to computing thread on the next available master computing unit 403. Typically, this will be a subordinate master computing unit 403. If each of the subordinate master computing units 403 is already occupied processing a previously assigned operation set, however, then the executive master computing unit 403 may assign the identified operation set to itself. Then, in step 507, the master computing unit 403 that has received the identified operation set obtains the portions of the design data needed to execute the identified operation set.

If the executive master computing unit 403 has assigned the identified operation set to itself, then it already will have the design data required to execute the operation set. If the executive master computing unit 403 has assigned the identified operation set to a subordinate master computing unit 403, however, then the subordinate master computing unit 403 will need to retrieve the required design data into its associated data storage unit 405. Accordingly, the subordinate master computing unit 403 will use the relationship information to determine which portions of the design information it will need to retrieve. For example, if the operation set consists of the operation
gate=diff AND poly
then the subordinate master computing unit 403 will use the relationship information to retrieve a copy of the diffusion drawn layer design data and the polysilicon drawn layer design data. If, however, the operation set consists of the operation
external gate<1
then the subordinate master computing unit 403 will only need to obtain the gate derived layer design data.

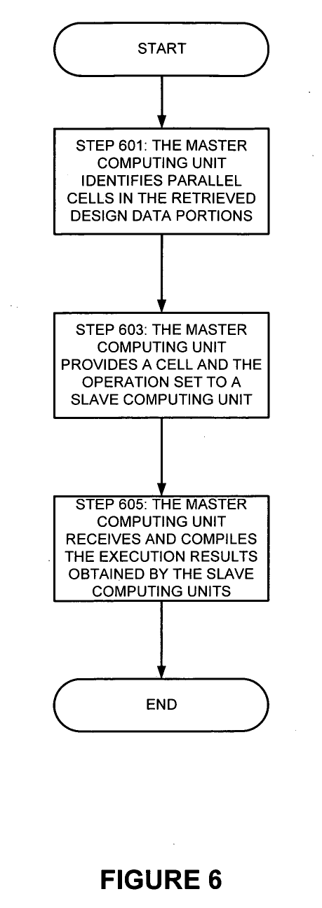

Next, in step 509, the master computing unit 403 that has received the identified operation set performs the identified operation set. The steps employed in performing an operation set are illustrated in FIG. 6. First, in step 601, the master computing unit 403 identifies parallel cells in the portions of the design data retrieved from master data storage unit 405. For example, if the operation set includes the operation
gate=diff AND poly
then both the retrieved diffusion layer design data and the polysilicon layer design layer may include portions of two or more parallel cells. That is, one portion of the diffusion and polysilicon layer design data may represent the polygons of diffusion and polysilicon materials included in one cell such as, e.g., a memory register circuit, while another portion of the diffusion and polysilicon layer design data may represent the polygons of diffusion and polysilicon materials included in another cell, such as, e.g., an adder circuit.

In step 603, the master computing unit 403 provides a design data cell portion with a copy of the operation set to an available slave computing unit 407 for execution. With some examples of the invention, the master computing unit 403 will provide every identified cell portion to a separate slave computing unit 407. With other examples of the invention, however, the master computing unit 403 may retain one cell portion for performing an operation set itself. In step 605, the master computing unit 403 receives and compiles the execution results obtained by the slave computing units 407. Steps 601-605 are then repeated until all of the retrieved design data cell portions have been processed using the assigned operation set. The master computing unit 403 then provides the compiled execution results to the executive master computing unit 403.

Returning now to FIG. 5B, in step 511, the master computing unit 403 that received the identified operation set returns the results, obtained by performing the operation set, to the executive master computing unit 403. The executive master computing unit 403 then adds the results to the process data in its data storage unit 405. Steps 501-511 are then repeated until each of the operations has been executed using the appropriate design data. In this matter, operations for the design rule check process can be distributed more widely among slave computing units 407, providing faster and more efficient execution of the operations.

Preliminary Execution of Operations

With some software applications, the algorithm used to perform an operation may be optimized for that operation. For example, the algorithm used to perform the operation
external metal<1
may be very different from the algorithm used to perform the operation
gate=diff AND poly

Some operations may implement identical or similar algorithms, however. For example, the algorithm used to perform the operation
internal metal<0.5
(i.e., an operation to check that every metal structure has a width of at least 0.5 microns) will be similar or identical to the algorithm used to perform the operation
external metal<1

Because these operations are independent, they can be more efficiently executed if they are executed concurrently. Thus, these operations are concurrent operations.

Various software applications, such as the CALIBRE software application available from Mentor Graphics Corporation of Wilsonville, Oreg., may have optimizations intended to ensure that concurrent operations are, in fact, executed concurrently. In order to ensure that these optimizations are taken into account when operation sets are identified, various implementations may perform a preliminary execution of the operations to identify concurrent operations. For example, because the CALIBRE software application does not pare empty operations and employs a programming language that does not allow conditional statements, various implementations of the invention may initially perform operations for this software application in a conventional linear order using “empty” design data (i.e., design data having nil values). With empty design data, all of the operations are performed very quickly. The resulting order in which the. operations were actually performed can then be used to form the operation tree that the executive master computing unit 403 will use to identify operation sets. That is, the order in which the operations were actually performed with nil values will group concurrent operations together. Concurrent operations can then be included in the same operation set by the executive master computing unit 403.

### CONCLUSION

Thus, the methods and tools for distributing operations described above provide reliable and efficient techniques for distributing operations among a plurality of master computers and then among one or more slave computers for execution. It should be appreciated, however, that various embodiments of the invention may omit one or more steps of the above-described methods. Alternately, some embodiments of the invention may omit considering whether a master computing unit, a slave computing unit, or both are available. For examples, these alternate embodiments of the invention may simply assign identified operations sets for execution on a sequential basis. Still further, alternate embodiments of the invention may rearrange the steps of the method described above. For example, the executive master computing unit may identify the next available master computing unit before identifying the next operation set to be performed.

Still other variations regarding the implementation of the invention will be apparent to those of ordinary skill in the art. For example, the operating environment illustrated in FIG. 1 connects a single master computer 101 to the slave computers 115 using a 1-to-N type communication interface. Alternate embodiments of the invention, however, may employ multiple master computers 101 to distribute operations to the slave computers 115. Further, the communication interface may be a bus-type interface that allows one slave computer 115 to redistribute operations to another slave computer 115. More particularly, one or more slave computers 115 may include the control functionality to execute embodiments of the invention to redistribute operations to one or more other slave computers. Thus, if the master computer 101 distributes multiple data cells to a slave computer 115 that can be broken up into smaller groups of cells, the slave computer 115 may then assign a portion of the cells to another slave computer 115 for execution. Additionally, various embodiments of the invention may employ multiple tiers of master/slave computers, such that a computer in one tier distributes operations to one or more computers in a second tier, which may then each distribute the operations among computers in a third tier. Moreover, some examples of the invention, may omit slave computers altogether. With these implementations of the invention, the performance of each operation set may be executed by a master computing unit 403. These and other variations will be apparent to those of ordinary skill in the art.

Thus, the present invention has been described in terms of preferred and exemplary embodiments thereof. Numerous other embodiments, modifications and variations within the scope and spirit of the appended claims will occur to persons of ordinary skill in the art from a review of this disclosure.

What is claimed is:

1. A method of distributing operations sets for execution, comprising:
providing a first operation set to a first master computing thread,
providing the first master computing thread with first process data associated with the first operation set, the first process data including at least a portion of first cell data and at least a portion of second cell data parallel to the first cell data;
providing a second operation set to a second master computing thread, the second operation set being parallel to the first operation set; and
providing the second master computing thread with second process data associated with the second operation set, the second process data including at least a portion of third cell data and at least a portion of fourth cell data parallel to the third cell data.

2. The method of distributing operations sets for execution recited in claim 1, further comprising having the second master computing thread provide the second operation set and the at least a portion of the first cell data to a first slave computing thread for execution.

3. The method of distributing operations sets for execution recited in claim 2, further comprising having the second master computing thread provide the second operation set and the at least a portion of the second cell data to a second slave computer thread for execution.

4. The method of distributing operations sets for execution recited in claim 2, further comprising having the second master computing thread execute the first operation set using the at least a portion of the second cell data.

5. The method of distributing operations sets for execution recited in claim 1, wherein:
the second master computing thread is a subordinate master computing thread, and
the first master computing thread is an executive master computing thread that provides the second operation set and the second process data to the second master computing thread.

6. The method of distributing operations sets for execution recited in claim 1,
providing a third operation set to a third master computing thread, the third operation set being parallel to the first and second operation sets; and
providing the third master computing thread with third process data associated with the third operation set, the third process data including at least a portion of fifth cell data and at least a portion of sixth cell data parallel to the fifth cell data.

7. The method of distributing operations sets for execution recited in claim 6, further comprising having the third master computing thread provide the third operation set and the at least a portion of the fifth cell data to a second slave computing thread for execution.

8. The method of distributing operations sets for execution recited in claim 7, further comprising having the third master computing thread provide the third operation set and the at least a portion of the sixth cell data to a second slave computer thread for execution.

9. The method of distributing operations sets for execution recited in claim 7, further comprising having the third master computing thread execute the third operation set using the at least a portion of the sixth cell data.

10. The method of distributing operation sets for execution recited in claim 1, wherein the process data is microdevice design data.

11. The method of distributing operations sets for execution recited in claim 10, wherein the operation sets are for executing a process selected from the group consisting of: a design rule check process, a layout versus schematic check process, a phase shift mask process, an optical process correction process, an optical process rule check process, and a resolution enhancement technique process.

12. The method of distributing operations sets for execution recited in claim 1, wherein the first operation sets contains a single operation.

13. The method of distributing operations sets for execution recited in claim 1, wherein the first operation sets contains a plurality of operations.

14. The method of distributing operations sets for execution recited in claim 13, wherein the first operation set contains concurrent operations.

15. The method of distributing operations sets for execution recited in claim 1, further comprising executing a plurality of operations using process data having nil values.

16. A processing tool, comprising:
an operation storage unit containing a plurality of operation sets, including a first operation set and a second operation set parallel to the first operation set;
a data storage unit containing
process data including first process data and second process data that is parallel to the first process data, and
relationship data that associates the first operation set with the first process data and associates the second operation set with the second process data;
a first master processing unit that processes the first operation set using the first process data, and
a second master processing unit that processes the second operation set using the second process data.

17. The tool recited in claim 16, wherein
the first process data includes at least a portion of first cell data and at least a portion of second cell data parallel to the first cell data; and
the first master processing unit processes the first operation units by providing the at least a portion of the first cell data and the first operation set to a first slave processing unit for execution.

18. The apparatus recited in claim 17, further comprising:
the first slave processing unit; and
a second storage unit containing the at least a portion of the first cell data.

19. The apparatus recited in claim 17, wherein the first master processing unit processes the first operation units by providing the at least a portion of the second cell data and the second operation set to a second slave processing unit for execution.

20. The apparatus recited in claim 17, the second process data includes at least a portion of third cell data and at least a portion of fourth cell data parallel to the third cell data; and
the second master processing unit processes the second operation set by providing the at least a portion of the third cell data and the second operation set to a second slave processing unit for execution.

21. The apparatus recited in claim 20, wherein the second master processing unit processes the second operation set by providing the at least a portion of the fourth cell data and the second operation set to a third slave processing unit for execution.

22. The apparatus recited in claim 16, further comprising:
a second data storage unit containing
the second process data that is parallel to the first process data, and
relationship data that associates the second operation set with the second process data; and
wherein the first master processing unit employs the first data storage unit to process the first operation set and the second master processing unit employs the second data storage unit to process the second operation set.
